(19) United States
(12) Patent Application Publication
(10) Pub. No.: US 2004/0111115 A1
(43) Pub. Date: Jun. 10, 2004

(54) Otologic adhesive applicator

(76) Inventor: Jennifer Maw, San Jose, CA (US)

Correspondence Address: Curtis D. Kinghorn, Medtronic, Inc., 710 Medtronic Parkway N.E., Minneapolis, MN, 55432, US

(21) Appl. No.: 10/664,099

(22) Filed: Sep. 17, 2003

Related U.S. Application Data
(60) Provisional application No. 60/411,628, filed on Sep. 17, 2002.

(51) Int. Cl. A61D 1/00

(52) U.S. Cl. 606/214

(57) ABSTRACT

Disclosed are applicators for applying medical adhesives or other media, particularly application of adhesives to small or delicate areas such as in the ear. Preferred applicators comprise a handle to hold the applicator and a trigger to actuate a dispensing mechanism which serves to express media or adhesive from a reservoir out through a cannula where is applied to the desired tissue or surface.

This application claims priority from U.S. Provisional Application No. 60/411,628 filed on Sept. 17, 2002.

### BACKGROUND OF THE INVENTION

1. Field of the Invention

This invention relates to applicators for applying medical adhesives, particularly application of adhesives to small or delicate areas such as in the ear.

2. Description of the Related Art

There are currently no FDA approved cyanoacrylate adhesives for otologic use. Fibrin adhesives are FDA approved (Tisseal, Heamaseal) and an applicator is included in the package. The applicator allows mixing of the components of the adhesive and application in the ear. The applicator is a double syringe with a needle tip, having no control mechanism to allow for controlled application of small quantities of the tissue adhesive. Generally, large quantities of fibrin adhesives are applied. As these adhesives are biocompatible, absorbed by the body, and help in hemostasis, there is little regard for the quantity that is applied to the ear. Fibrijet Duplotip applicators (Baxter) are available for otologic use. They provide a finer bore than that supplied with the tissue adhesive. The surgeon must depress the end of the syringe, but there is no mechanism to contol the amount that is dispensed through the tip. There is inadequate control through this type of free-flowing syringe to consider its use for applying a material such as cyanoacrylate.

Intratympanic application of medications for Meniere's Disease and Sudden Sensorineural Hearing Loss (steroids, gentamycin) is performed in the office setting with a tuberculin syringe and needle. The Silverstein Microwick also delivers medications to the round window through the tympanic membrane, but is not used to apply medications in an operative setting. Intratympanic delivery of medications can be delivered via a Round Window Microcatheter (Durect Corporation) attached to a Panomat C Pump for continuous delivery. This is implanted via a tympanoplasty procedure and is removed in 7-10 days.

There are no available devices for the application of microliter quantities of medications or adhesives during otologic or skull base surgery. If a medication is desired in the ear, gelfoam is saturated and placed in the middle ear. If a surgeon's intent is to use a cyanoacrylate adhesive as an off-label procedure, a small quantity must be placed into a syringe and squirted or placed in a bowl and scooped up with an otologic instrument. Generally, medical grade cyanoacrylates that are commercially available are too thin to easily be applied in this regard. Squirting such adhesives through a syringe is uncontrolled and risks run-off over the stapes bone which could then become fixed and cause a conductive hearing loss. The cyanoacrylate adhesive also sticks to the instruments which then must be scraped clean.

### SUMMARY OF THE INVENTION

Cyanoacrylates are now being developed and may become available for otologic use. A delivery device is needed for their precision application to the ear and skull base. The described device may also be used to deliver precise aliquots of other adhesives, medications or materials.

In accordance with a preferred embodiment, there is provided an applicator for applying small amounts of media to a site within or upon an animal body. The applicator comprises an applicator body comprising a handle and a trigger movably connected to the handle or body, the movement of which causes a dispensing mechanism within the applicator body to press upon a plunger residing within a reservoir containing media thereby forcing at least a portion of the media out of the reservoir and through a cannula attached to the reservoir. In preferred embodiments, the media is a medical or surgical adhesive. In preferred embodiments, the dispensing of media is metered. In one metered applicator, the dispensing mechanism comprises a ratchet mechanism, preferably comprising a process on the trigger which engages grooves or teeth on a rod portion of the dispensing mechanism.

In accordance with a preferred embodiment, there is provided a method of applying a small amount of media to a site on or in the body of an animal. The method comprises providing an applicator as described above, placing the tip of the cannula on or near a surface to which application of media is desired, and moving the trigger, thereby expressing media from the tip of the cannula to the surface. In one preferred method, the media is an adhesive, preferably a thickened cyanoacrylate adhesive and the surface is one or more of the ossicles of the ear.

### BRIEF DESCRIPTION OF THE DRAWINGS

FIG. 1 is a plan view of one preferred embodiment of adhesive applicator.

FIG. 2 is a partial cross-section through the adhesive applicator of FIG. 1.

### DETAILED DESCRIPTION OF THE PREFERRED EMBODIMENTS

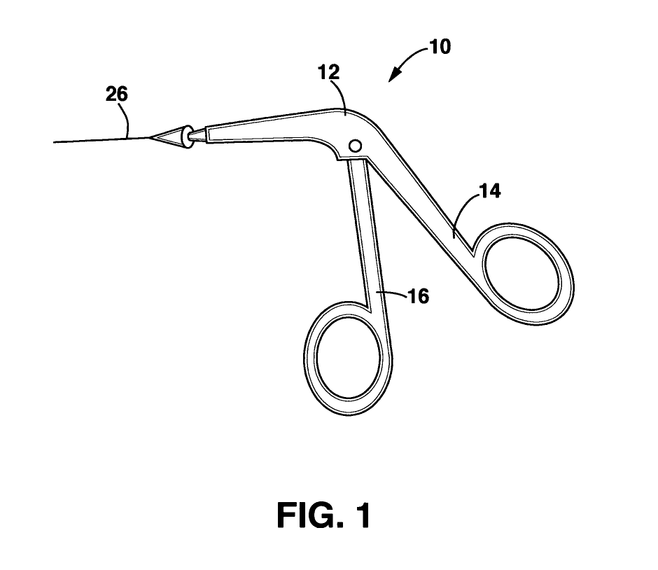

Referring to FIG. 1, there is illustrated one preferred embodiment of adhesive applicator 10. The applicator 10 comprises a body 12 and a catheter or cannula 26 through which the adhesive is expressed. The body 12 comprises a handle 14 and trigger 16. The handle 14 allows the applicator to be securely held in the hand. In the illustrated embodiment, the handle 14 comprises a ring at a terminus so as to allow a finger, or preferably the thumb, to be placed in the ring to allow for a secure hold on the applicator 10 which also aids in the steadying of the applicator 10. The trigger 16 is movably attached to the body 12. In the illustrated embodiment, the trigger is attached to the body by means of a joint which allows for the trigger to pivot about the joint when the trigger 16 is squeezed. In the illustrated embodiment, the trigger 16 has a ring at one terminus to allow for insertion of a finger for operation of the trigger 16. As noted earlier, the ring terminus is merely preferred for the ease of holding and control that it provides; the use of other designs and structures is presently contemplated. Although in the illustrated embodiment, the trigger 16 is shown separate from the handle 14, in other embodiments the trigger 16 may be attached to the handle 14. Furthermore, means of attachment and actuation of the trigger 16 other than those illustrated may be used.

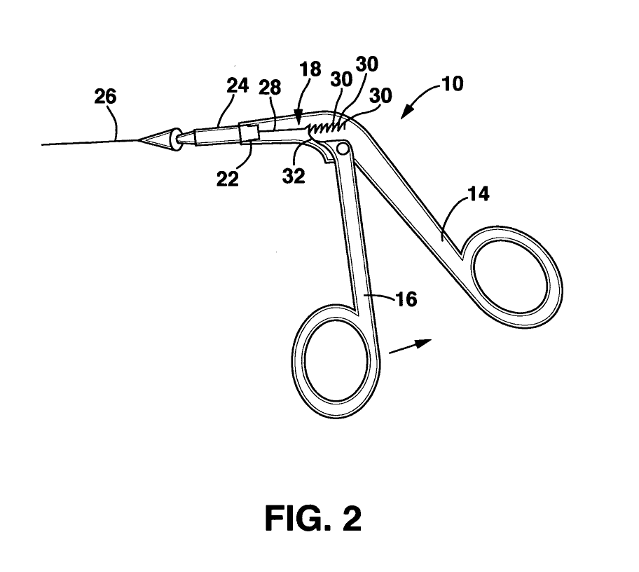

As can be seen with reference to FIG. 2, the body also comprises a dispensing mechanism 18. The dispensing mechanism preferably comprises a rod 28 which may be attached to a plunger 22, capable of engaging a plunger 22 on the reservoir 24 or attached to a plate or enlarged region which then engages a plunger 22 on the reservoir 24. The trigger 16 is connected, directly or through other parts, to the rod 28 such that movement of the trigger 16 causes movement of the rod 28 to depress the plunger 22, resulting in expulsion of adhesive or other media from the reservoir 24. In preferred embodiments, the dispensing mechanism 18 allows for metering (i.e. dispensing of a discrete, measured amount) of the adhesive or other media. The illustrated embodiment allows for metering, which is accomplished by a ratchet mechanism. The illustrated ratchet mechanism comprises a series of teeth or grooves 30 on a portion of the rod 28 that are engaged by a process 32 on the upper end of the trigger 16. Movement of the trigger 16 causes the process 32 to engage a tooth or groove 30 and move it a finite, predetermined distance when the trigger 16 is pulled or depressed completely (i.e. moved in the direction of the arrow until it meets the handle 14). In one preferred embodiment, use of a ratchet mechanism results in the delivery of about 5-10 μL of adhesive or other media when the trigger 16 is fully depressed.

The reservoir 24 holds the adhesive or other media and may be contained entirely within the body 12 or reside fully or partially outside the body 12. The reservoir 24 may be fixed to the body 12, or it may be removably connected to the body 12 such as by a compression fitting or a screw fitting. At one end of the reservoir 24 is the plunger 22 which preferably slidably engages the wall of the reservoir 24 and, when slid toward the opposite end of the reservoir 24, serves to expel the adhesive through an opening on or near the opposite end of the reservoir 24 where the cannula or catheter 26 is attached. The reservoir 24 may be made of any suitable material, such as glass, plastic, metal or combinations thereof; preferably a material which is compatible with the adhesive or media it houses. In one embodiment, the reservoir 24 comprises a transparent or translucent material that allows for visual inspection of the adhesive or medium contained therein. In one embodiment, the reservoir is sized to hold up to 1.0 ml of adhesive or medium, including 0.8 ml, 0.5 ml, and 0.2 ml. The cannula or catheter 26 may be permanently affixed to the reservoir 24 or it may be removably attached such as by a screw fitting, compression fitting, or luer-lock fitting. In a preferred embodiment, the cannula 26 is about 10 to 50 gauge, including about 25 gauge. In any case, the bore within the cannula 26 should be sized so as to be compatible with the quantity and viscosity of the adhesive to be expressed therethrough. The length of the cannula 26 is preferably selected to be a length long enough to reach the intended application site, but not too much longer, as excess cannula length can make precise application more difficult.

The material held within the reservoir 24 and delivered by the applicator 10 may be any type of media for which precise application is desired in a medical, surgical, or veterinary context, including adhesives, sealants, hemostatic agents, drugs, and the like. In a preferred embodiment, the material delivered is an adhesive. Preferred adhesives include, but are not limited to, cyanoacrylate adhesives, fibrin-based adhesives, and other medically useful adhesives. The viscosity of the adhesive or media used can be chosen from within a wide range to suit the particular procedure or indication. In one preferred embodiment, the adhesive is a thickened cyanoacrylate adhesive, that is an adhesive having a viscosity greater than about 2,000 cps and/or as high as 100,000 cps. Such adhesives are disclosed in U.S. Pat. Nos. 6,155,265 and 6,386,203, the disclosures of which are hereby incorporated by reference in their entireties.

The applicator 10 is preferably primed with adhesive or other media prior to use. Use of the applicator 10 proceeds by placing the tip of the cannula 26 in contact with or near a surface and then pulling or otherwise moving the trigger 16 to cause the expression of a small, and in the case of metering applicators, defined, amount of media or adhesive from the tip of the cannula 26. The applicator thus allows for precise application of small amounts of adhesive and avoids applying too large of an amount of adhesive or media and/or applying adhesive or media into unwanted areas such as may cause mechanical complications and/or toxicity.

One preferred use of the device is for the bonding of the ossicles in otologic surgery. It should be noted, however, that other applications are foreseen, especially those which may require precise application of materials, such as in neurotology, neurosurgery, microsurgical procedures, precision wound closure, and endoscopic procedures. The applicator may be used to seal blood vessels, nerves, bones, bowel, and other tissues, or to apply other media to locations inside or outside the body.

The various methods and apparatus described above provide a number of ways to carry out the invention. Of course, it is to be understood that not necessarily all objectives or advantages described may be achieved in accordance with any particular embodiment described herein. Thus, for example, those skilled in the art will recognize that the methods may be performed and the apparatus built in a manner that achieves or optimizes one advantage or group of advantages as taught herein without necessarily achieving other objectives or advantages as may be taught or suggested herein.

Furthermore, the skilled artisan will recognize the interchangeability of various features from different embodiments, illustrated or not illustrated. Similarly, the various features discussed above, as well as other known equivalents for each such feature, can be mixed and matched by one of ordinary skill in this art to perform methods in accordance with principles described herein.

Although the invention has been disclosed in the context of certain embodiments, it will be understood by those skilled in the art that the invention extends beyond the specifically disclosed embodiments to other alternative embodiments and/or uses and obvious modifications and equivalents thereof.

1. An adhesive applicator for applying medical adhesives to an ear comprising:
a body having:
a handle having a terminus;
a trigger pivotally connected to the handle through a joint which allows the trigger to pivot about the joint when the trigger is squeezed;
a reservoir having a first end and a second end;
a dispensing mechanism operatively connected at one end to the trigger and at the other end to the reservoir; and
a catheter or cannula fluidly connected to the second end of the reservoir through which the adhesive is expressed.

2. The applicator of claim 1 wherein the handle comprises a ring at the terminus sized to allow a finger or a thumb to be placed in the ring.

3. The applicator of claim 1 wherein the reservoir is cylindrical and wherein the dispensing mechanism comprises:
a cylindrical plunger located at least partially in the reservoir and dimensioned so that the outer diameter of the plunger is approximately equal to the inner diameter of the reservoir,
a rod having a first end attached to the trigger and a second end attached to the plunger, the rod capable of moving the plunger into and out of the reservoir as the trigger is moved around the joint.

4. The applicator of claim 3 wherein dispensing mechanism is a ratchet mechanism comprising a series of teeth or grooves on a portion of the rod and a process on the upper end of the trigger that engages the teeth or groove whereby movement of the trigger causes the process to engage a tooth or groove and move it a finite, predetermined distance when the trigger is pulled or depressed.

5. The applicator of claim 1 wherein the dispensing mechanism is a ratchet mechanism.

6. The applicator of claim 1 wherein the reservoir is fixed to the body.

7. The applicator of claim 1 wherein the reservoir is removably connected to the body.

8. The applicator of claim 7 wherein the reservoir is removably connected to the body by means selected from the group consisting of a compression fitting or a screw fitting.

9. The applicator of claim 1 wherein the reservoir is made of a material that is transparent or translucent.

10. The applicator of claim 1 wherein the cannula or catheter is permanently affixed to the reservoir.

11. The applicator of claim 1 wherein the cannula or catheter is removably attached to the reservoir.

12. The applicator of claim 11 wherein the cannula or catheter is removably attached to the reservoir by means selected from the group consisting of screw fitting, compression fitting or luer-lock fitting.

13. The applicator of claim 1 wherein the cannula or catheter is preferably between about 10 to 50 gauge.

14. The applicator of claim 13 wherein the cannula or catheter is more preferably about 25 gauge.

15. The applicator of claim 1 further comprising an adhesive contained in the reservoir.

16. The applicator of claim 15 wherein the adhesive is a cyanoacrylate adhesive.

17. The applicator of claim 15 wherein the adhesive is a fibrin-based adhesive.

18. A method of treating maladies of the ear comprising the steps of:
providing an adhesive applicator for applying medical adhesives to an ear comprising:
a body having:
a handle having a terminus;
a trigger pivotally connected to the handle through a joint which allows the trigger to pivot about the joint when the trigger is squeezed;
a reservoir having a first end and a second end;
a dispensing mechanism operatively connected at one end to the trigger and at the other end to the reservoir; and
a catheter or cannula fluidly connected to the second end of the reservoir through which the adhesive is expressed, the catheter or cannula having a tip;
priming the applicator with adhesive or other media prior to use;
placing the tip of the catheter or cannula in contact with or near a surface in the ear; and
pulling or otherwise moving the trigger to interact with the dispensing mechanism and the dispensing mechanism to interact with the reservoir to cause the expression of an amount of media or adhesive to be expressed from the tip of the catheter or cannula.

19. A method of performing medical treatments selected from the group consisting of sealing blood vessels, nerves, bones, bowel, and other tissues or applying media to locations inside or outside the body comprising the steps of:
providing an adhesive applicator for applying medical adhesives to an ear comprising:
a body having:
a handle having a terminus;
a trigger pivotally connected to the handle through a joint which allows the trigger to pivot about the joint when the trigger is squeezed;
a reservoir having a first end and a second end;
a dispensing mechanism operatively connected at one end to the trigger and at the other end to the reservoir; and
a catheter or cannula fluidly connected to the second end of the reservoir through which the adhesive is expressed, the catheter or cannula having a tip;
priming the applicator with adhesive or other media prior to use;
placing the tip of the catheter or cannula in contact with or near a surface in or on a portion of a body; and
pulling or otherwise moving the trigger to interact with the dispensing mechanism and the dispensing mechanism to interact with the reservoir to cause the expression of an amount of media or adhesive to be expressed from the tip of the catheter or cannula.
